(19) United States
(12) Patent Application Publication
(10) Pub. No.: US 2003/0230631 A1
(43) Pub. Date: Dec. 18, 2003

(54) IC card

(75) Inventors: Hisataka Tsunoda, Omama (JP); Keisuke Takata, Fujioka (JP); Kazuki Watanabe, Kokubunji (JP); Norihisa Yamamoto, Kodaira (JP); Kazuhiro Matsushita, Kodaira (JP)

Correspondence Address: Miles & Stockbridge P.C., Suite 500, 1751 Pinnacle Drive, McLean, VA, 22102-3833, US

(73) Assignees: Hitachi, Ltd.; Hitachi ULSI Systems Co., Ltd.

(21) Appl. No.: 10/449,090

(22) Filed: Jun. 2, 2003

(30) Foreign Application Priority Data
Jun. 17, 2002 (JP) 2002-175189

(51) Int. Cl. G06K 19/06

(52) U.S. Cl. 235/492

(57) ABSTRACT

In an IC card of dual-way type which is used in common as a non-contact/contact operation card, an isolation transistor is provided between a power supply voltage terminal and a contact power supply circuit. Non-contact/contact judging and switching unit 6 turns OFF, when it is detected that the IC card is operated in a non-contact operation mode, an isolation transistor to isolate between the power supply voltage terminal and contact power supply circuit. Accordingly, when the power supply voltage terminal is terminated with a ground terminal during the non-contact operation mode, erroneous operation of the IC card can surely be prevented. Since the power supply voltage terminal becomes equal to a reference potential in this case, monitoring of voltage of the power supply voltage terminal can be prevented and security of the IC card can also be improved remarkably.

### BACKGROUND OF THE INVENTION

The present invention relates to an IC card and more specifically to the technique to be effectively applied for improvement of reliability of a dual-way type IC card.

In these years, an IC card having functions of a credit card and a telephone card is widely spreading. This IC card is provided with a CPU and a memory mounted to the card of the same shape as a magnetic card. The read/write operation of the memory is controlled with the CPU and the card itself has the functions of cryptographic process and higher security and also has the higher storage capacity.

In addition, as an information transmitting system for external devices, the IC card may be classified to a contact type card, for example, including a mechanical coupling means for the external device, a non-contact type card for transmitting information with an information transmission medium such as radio wave and a contact/non-contact type card, so-called a dual-way type card.

In the case of the dual-way type IC card, the power supplied from the power supply input terminal of the contact type card and the power supplied from the radio wave of the non-contact type card are mixed in the common power supply line and are then supplied to the internal power supply regulator.

In this case, since the power supply line is used in common, the power source voltage is also supplied to the power supply terminal, which is used in the contact-operation period, during the non-contact operation period of the IC card. Accordingly, there rises a fear for erroneous operation when the power supply voltage (VDD) terminal is terminated to the ground (GND) terminal with a certain reason such as contact between the metal materials.

As the technique for preventing erroneous operation of the IC card due to the short-circuit of power supply voltage terminal and ground terminal, it is known, as disclosed in the Japanese Unexamined Patent Application Publication No. 2000-14896, that a diode is inserted to the side of the power supply voltage VDD of the power supply line in order to prevent reverse flow of current to the ground terminal from the power supply voltage terminal.

### SUMMARY OF THE INVENTION

However, the inventors of the present invention have found following problems in the reverse current preventing technique of the IC card described above.

Namely, when a reverse current preventing diode is inserted to the power supply line of the IC card, the power source voltage supplied to the power supply terminal during the contact operation is dropped due to the forward voltage (VF) of this diode and thereby the operation range of the power supply is narrowed, resulting in the fear for deterioration of reliability of the IC card.

Moreover, the dual-way type IC card has a problem that change of power supplied from an antenna is monitored from the power supply terminal during non-contact operation. Monitoring of change of power cannot be prevented perfectly even when the diode is inserted into the power supply line and security hole may be generated because the internal operation of a semiconductor integrated circuit device of the IC card is analyzed by reading such change of power.

It is therefore an object of the present invention to provide an IC card which can prevent erroneous operation due to the short-circuit between the power supply terminals during the non-contact operation and also can remarkably improve security by preventing the monitoring of change of power.

The aforementioned and other objects and the novel features of the present invention will become apparent from the description of the present specification and the accompanying drawings thereof.

The typical inventions of the present invention disclosed in this specification may be briefly described as follows.

1. There is provided an IC card of the dual-way type which can be used in common for the contact and non-contact type operations and is provided with an operation mode detecting unit for outputting the control signal by detecting the non-contact operation and an isolation switch means for isolating the contact power supply terminal and internal power supply based on the control signal of the operation mode detecting unit. The other inventions will also be briefly described below.

2. In the item 1 described above, the contact power supply terminal is composed of at least any one of the power supply voltage terminal or reference potential terminal.

3. In the items 1 and 2 described above, the isolation switch means is composed of two P-channel MOS transistors connected in series.

4. In any one item among the items 1 to 3, the isolation switch means is provided at the area near the contact power supply terminal.

5. In any one item among the items 1 to 4, transistor size of the P-channel MOS transistor is larger than the MOS transistor for logical operations.

6. In any one item among the items 1 to 5, the operation mode detecting unit generates a DC voltage by rectifying the received radio wave and judges the non-contact operation by detecting such DC voltage.

### BRIEF DESCRIPTION OF THE DRAWINGS

FIG. 1 illustrates an IC card as an embodiment of the present invention.

FIG. 2 is a block diagram of a semiconductor integrated circuit device comprised in the IC card of FIG. 1.

FIG. 3 is a block diagram of the non-contact RF unit provided in the semiconductor integrated circuit device of FIG. 2.

FIG. 4 is a structural diagram of a non-contact/contact judging and switching unit provided in the non-contact RF unit of FIG. 3.

FIG. 5 is a timing chart of respective signals in each circuit of the non-contact RF unit of FIG. 4.

FIG. 6 is a chip layout in the semiconductor integrated circuit device comprised in the IC card of FIG. 1.

FIG. 7 is a cross-sectional view of the transistor provided in the non-contact RF unit of FIG. 4.

FIG. 8 is an equivalent circuit diagram of the transistor of FIG. 7.

FIG. 9 illustrates comparison of device size with the P-channel MOS transistor for transistor logic of FIG. 7.

FIG. 10 is a block diagram of the non-contact RF unit provided in the semiconductor integrated circuit device comprised in the IC card as the other embodiment of the present invention.

### DETAILED DESCRIPTION OF THE PREFERRED EMBODIMENTS

The preferred embodiments present invention will be described with reference to the accompanying drawings.

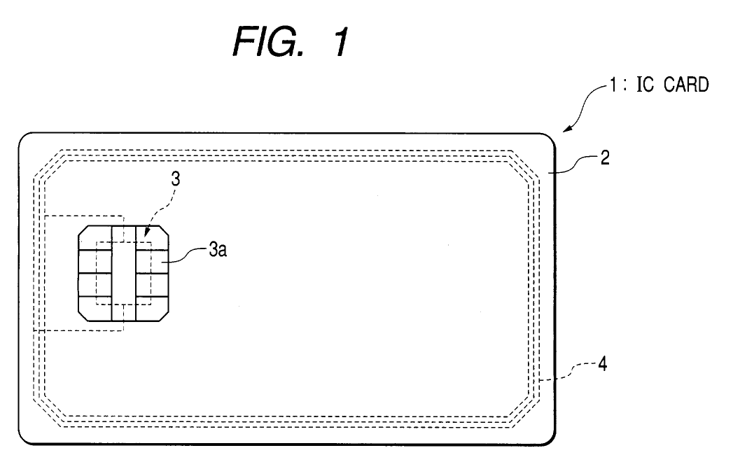

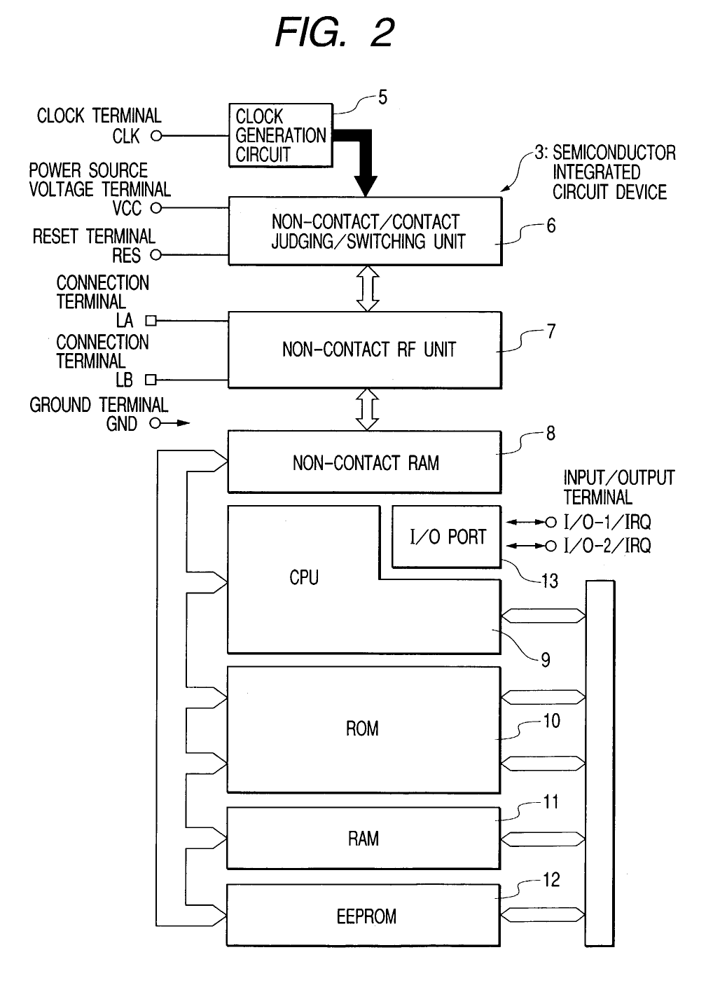

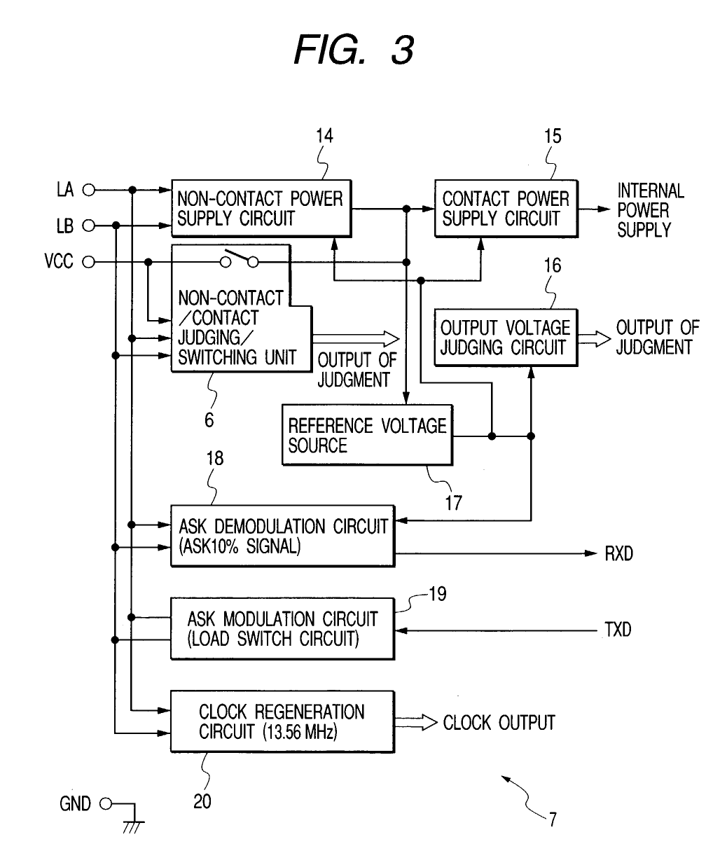

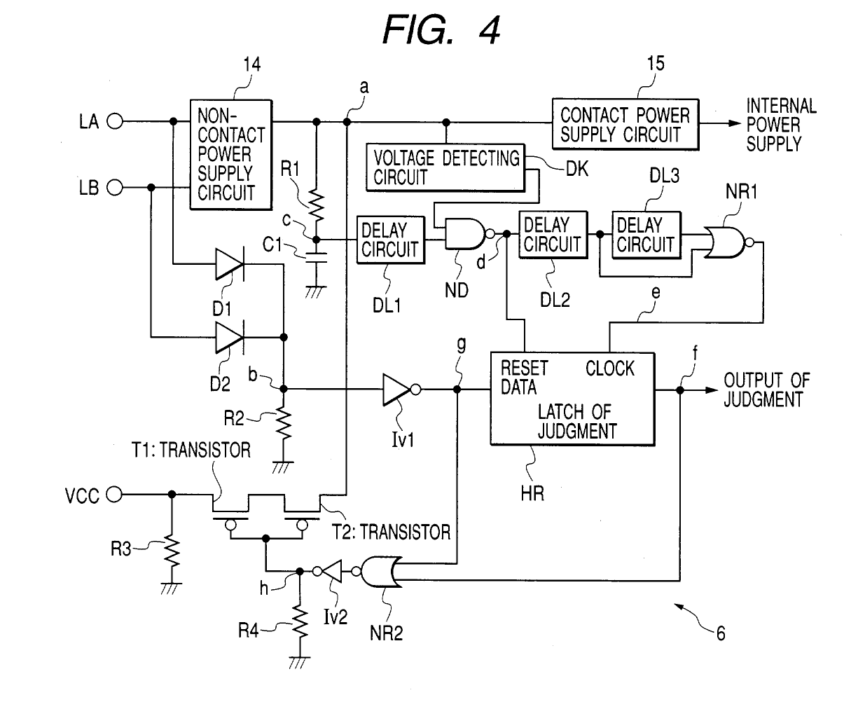

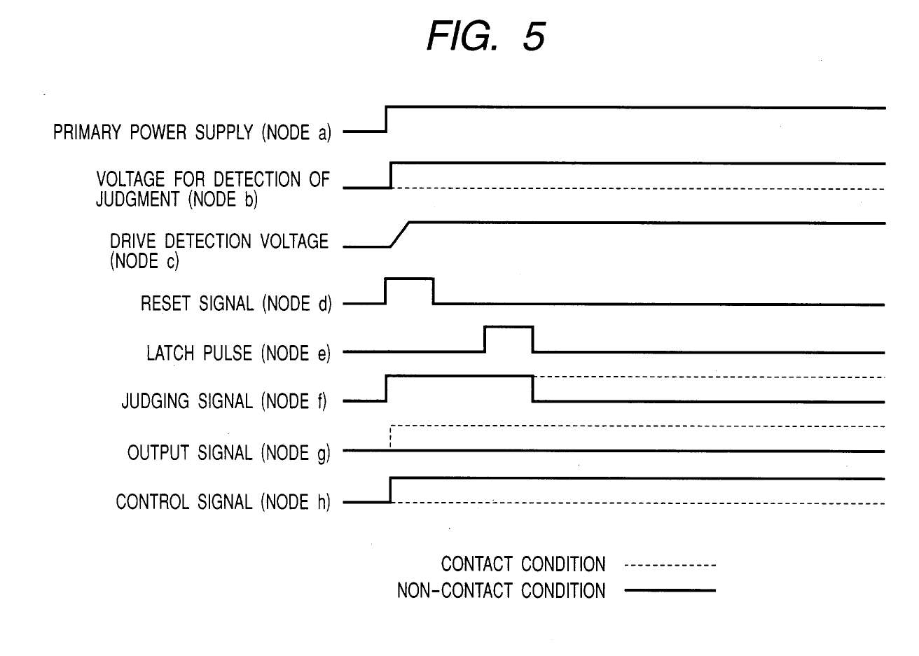

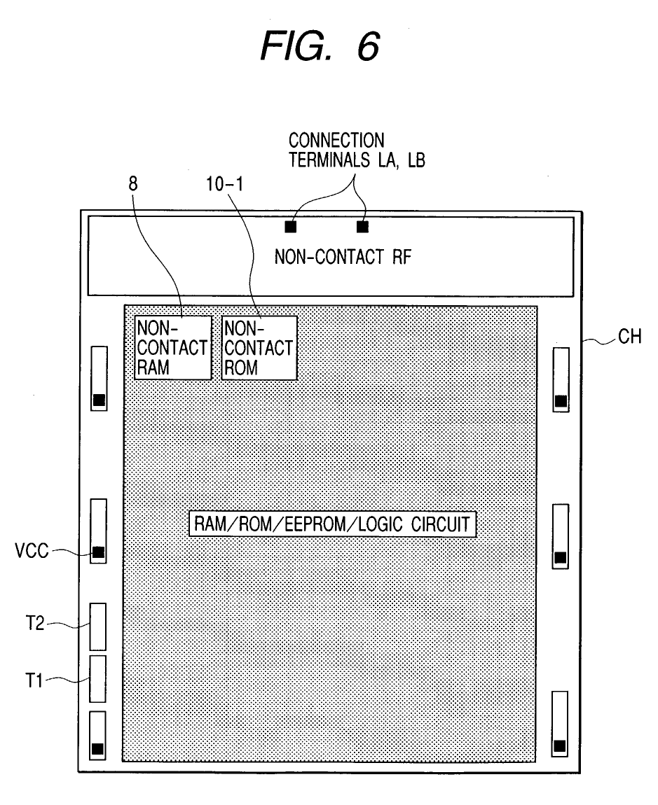

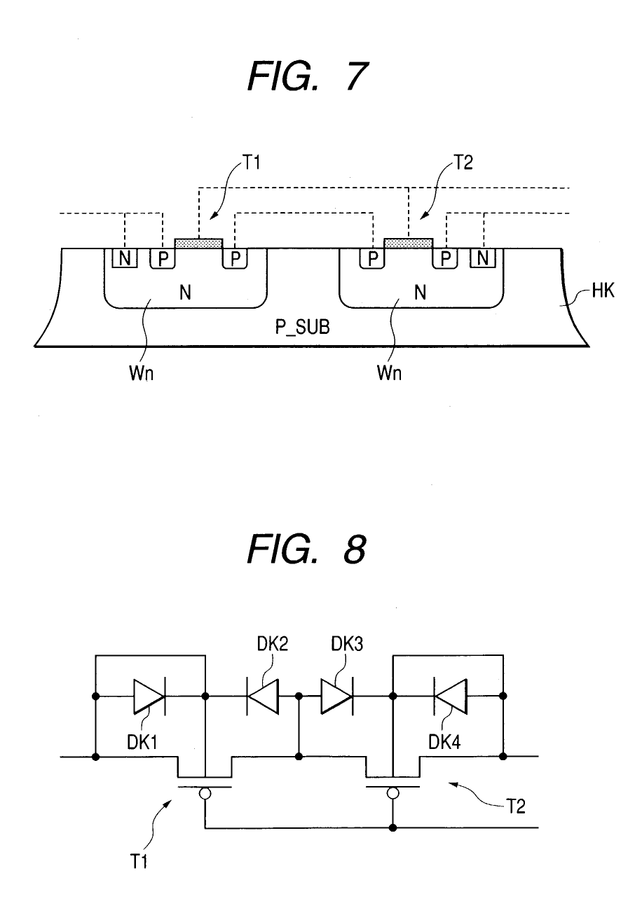

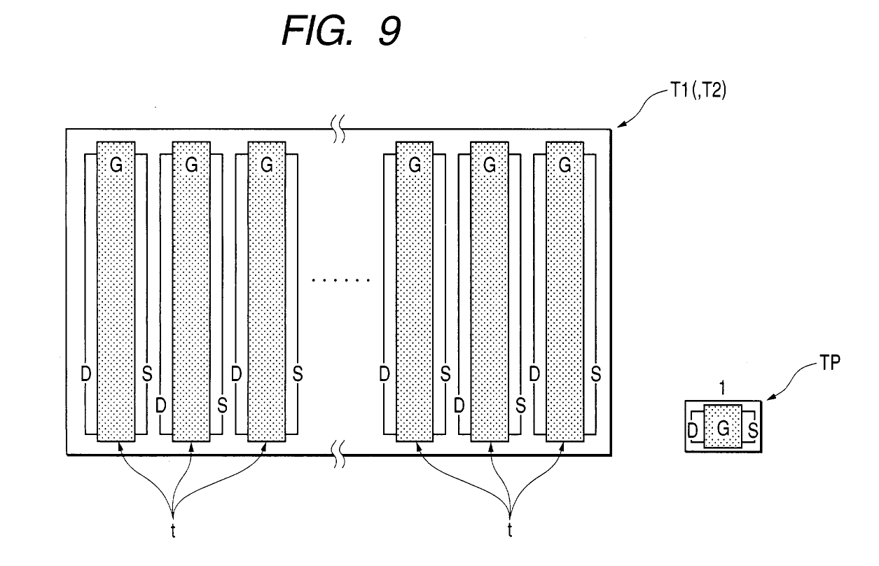

FIG. 1 illustrates an IC card of an embodiment of the present invention. FIG. 2 is a block diagram of a semiconductor integrated circuit device comprised in the IC card of FIG. 1. FIG. 3 is a block diagram of an non-contact RF unit provided in the semiconductor integrated circuit device of FIG. 2. FIG. 4 is a structural diagram of a non-contact/contact judging and switching unit provided in the non-contact RF unit of FIG. 3. FIG. 5 is a timing chart of respective signals at each circuit in the non-contact RF unit of FIG. 4. FIG. 6 is a chip layout diagram of the semiconductor integrated circuit device comprises in the IC card of FIG. 1. FIG. 7 is a cross-sectional view of a transistor provided in the non-contact RF unit of FIG. 4. FIG. 8 is an equivalent circuit diagram of the transistor of FIG. 7. FIG. 9 illustrates comparison of device size with the P-channel MOS transistor for transistor logic.

In this embodiment of the present invention, an IC card 1 is composed of a so-called dual interface IC card which may be used in common for the contact and non-contact operations. In the IC card 1, a semiconductor integrated circuit device 3 is embedded in a plastic card 2 of the shape similar to a magnetic card.

Moreover, a coil 4 which works as an antenna is also embedded in the area near the external circumference of the plastic card 2. Both terminals of this coil 4 are connected to the connection terminals LA, LB (FIG. 2) of the semiconductor integrated circuit device 2.

The coil 4 receives the radio wave from a card terminal when the IC card 1 is operated in the non-contact operation mode for supply of power and information communication.

On the surface of the plastic card 2, a plurality of external terminals 3a of the semiconductor integrated circuit device 3 are provided as the exposed terminals. These external terminals 3a are used for supply of power and information communication through the mechanical contact with the external terminals of the card terminal when the IC card 1 is operated in the contact operation mode.

In addition, as illustrated in FIG. 2, the semiconductor integrated circuit device 3 is composed of a clock generating circuit 5, a non-contact/contact judging and switching unit (operation mode detecting unit) 6, a non-contact RF unit 7, a non-contact RAM 8, a CPU 9, a ROM 10, a RAM 11, an EEPROM 12 and an I/O port 13 or the like.

The semiconductor integrated circuit device 3 is provided, as the external terminals 3a, with a clock terminal CLK, a power supply voltage terminal (contact power supply terminal) VCC, a reset terminal RES, a ground terminal (contact power supply terminal, reference potential terminal) GND and input/output terminals I/O 1, I/O 2.

An external clock signal is supplied to the clock terminal CLK. A power supply voltage is supplied to the power supply terminal VCC, while a reset signal is inputted to the reset terminal RES. A reference potential VSS is also connected to the ground terminal GND, while the data is inputted to or outputted from the input/output terminals I/O 1, I/O 2.

The clock generating circuit 5 generates an internal clock signal from the clock signal supplied from the clock terminal CLK. The non-contact/contact judging and switching unit 6 judges, when the IC card 1 is operated, the contact operation or non-contact operation by detecting whether a voltage is applied to the coil 4 or not to control the switching operation of the internal clock signal and to electrically disconnect the power supply voltage terminal VCC when the IC card 1 is operated in the non-contact mode.

The non-contact RF unit 7 has the high frequency interface function to become effective when the IC card 1 is operated in the non-contact mode and both ends of the coil 4 are connected via the connection terminals LA, LB.

Moreover, the non-contact RAM 8, CPU 9, ROM 10, RAM11 and EEPROM 12 are connected with each other with an internal bus B. The non-contact RAM 8 is a volatile memory to temporarily store the data inputted and outputted to and from the IC card 1 when this IC card 1 is operated in the non-contact mode.

The CPU 9 performs total control for the IC card on the basis of the program stored in the ROM 10. The ROM 10 is a read-only memory to store the control program of the IC card 1.

The RAM 11 is composed of a volatile memory to temporarily store the data inputted to or outputted from the IC card 1 when the IC card is operated in the contact mode. The EEPROM 12 is an electrically erasable and re-programmable memory to store the data which is temporarily stored in the non-contact RAM8 or RAM11. The I/O port 13 is the port for inputting and outputting the data from the card terminal.

Moreover, structure of the non-contact RF unit 7 will be explained with reference to the block diagram of FIG. 3.

The non-contact RF unit 7 is composed of a non-contact power supply circuit 14, a contact power supply circuit 15, an output voltage judging circuit 16, a reference voltage power supply 17, an ASK demodulating circuit 18, an ASK modulating circuit 19 and a clock regeneration circuit 20.

The non-contact power supply circuit 14 is the power supply circuit formed of a rectifying circuit and a regulator or the like. This non-contact power supply circuit 14 generates an internal power supply voltage as the operation voltage of the IC card 1. The coil 4 extracts a power from the radio wave outputted from the card terminal and then supplies this power to the non-contact power supply circuit 14.

The contact power supply circuit 15 is formed of a regulator or the like and generates an internal power supply voltage from the power supply voltage supplied from the power supply voltage terminal VCC when the IC card 1 is operated in the non-contact mode. The output judging circuit 16 detects a voltage level of the internal power supply voltage and outputs the reset signal when the voltage reaches the predetermined level to reset the semiconductor integrated circuit device.

The reference voltage power supply 17 is formed, for example, of a band gap circuit to generate the reference voltage from the internal power supply voltage and then supply this reference voltage to the non-contact power supply circuit 14, contact power supply circuit 15, output voltage judging circuit 16 and ASK demodulating circuit 18.

The ASK demodulating circuit 18 demodulates the data of the ASK (Amplitude Shift Keying) signal in which the amplitude of carrier received by the coil 4 is changed depending on the input digital signal and then outputs the demodulated signal to the non-contact RAM 8.

The ASK modulating circuit 19 modulates the data outputted from the non-contact RAM 8 with the ASK modulation method and then transmits the modulated signal from the coil 4. The clock regeneration circuit 20 generates the internal clock signal of about 13.56 MHz from the clock signal received by the coil 4 and then outputs this internal clock signal as the operation clock signal of the semiconductor integrated circuit device 3.

Moreover, connection structure of the non-contact/contact judging and switching unit 6 will be described with reference to FIG. 4.

The non-contact/contact judging and switching unit 6 is composed of diodes D1, D2, resistors R1 to R4, a capacitor C1, P-channel MOS transistors (isolation switch means) T1, T2, inverters Iv 1, Iv 2, a NOT-AND circuit ND, NOT-OR circuits NR 1, NR 2, a voltage detection circuit DK, delay circuits DL1 to DL3 and a judging latch HR.

The connection terminal LA to which one end of the coil 4 is connected is respectively connected to the anode of diode D1 and one input of the non-contact power supply circuit 14. The connection terminal LB to which the other end of the coil 4 is connected is also respectively connected to the anode of diode D2 and the other input of the non-contact power supply circuit 14.

The cathodes of diodes D1, D2 are connected to one connecting point of the resistor R2 and to the input of the inverter Iv 1 and these diodes D1, D2 provide the outputs of rectified power from the power fetched from the coil 4.

The output of the non-contact power supply circuit 14 is respectively connected with one connecting point of the resistor R1, the other connecting point of the transistor T2, input of the voltage detecting circuit DK and input of the contact power supply circuit 15. The non-contact power supply circuit 14 rectifies the power fetched from the coil 4 and outputs the stabilized power.

The other connecting point of the resistor R1 is respectively connected with one connecting point of the capacitor C1 and input of the delay circuit DL1, while the other connecting point of the capacitor C1 is connected with the reference potential VSS. These resistor R1 and capacitor C1 form a time constant circuit.

The output of delay circuit DL1 is connected with the other input of the NOT-AND circuit ND, while one connecting point of the NOT-AND circuit ND is connected with the voltage detection signal of the voltage detection circuit DK.

The output of NOT-AND circuit ND is connected with the input of delay circuit DL2 and the reset terminal of the judging latch HR consisting of flip-flop circuit. The output of delay circuit DL2 is connected with the input of delay circuit DL3 and the other input of NOT-AND circuit NR 1, while one input of NOT-OR circuit NR 1 is connected with the output of delay circuit DL3.

The output of NOT-OR circuit NR 1 is connected with the clock terminal of judging latch HR. The signal outputted from the output of judging latch HR becomes the judging signal of the non-contact/contact judging and switching unit 6. The output of judging latch HR is connected with the other input of the NOT-OR circuit NR 2.

One connecting point of resistor R3 and one connecting point of transistor T1 are respectively connected with the power supply voltage terminal VCC. The other connecting point of transistor T1 is connected with one connecting point of transistor T2 and the gates of these transistors T1, T2 are respectively connected with one connecting point of resistor R4 and the output of inverter Iv 2.

These transistors T1, T2 operate as the switches for separating the power supply voltage terminal VCC from the internal power supply line of the contact power supply circuit 15 or the like. The transistors T1, T2 turn ON when the IC card 1 operates in the contact mode and turns OFF when the IC card 1 operates in the non-contact mode to electrically separate the power supply voltage terminal VCC from the internal power supply line as described above.

Accordingly, the power supply voltage terminal VCC is fixed to the reference potential VSS with the resistor R3.

Moreover, the other connecting points of resistors R3, R4 are connected with the reference potential VSS, while the inputs of inverters Iv 1, 2 are connected with the output of the NOT-OR circuit NR 2.

The other connecting point of resistor R 2 is connected with the reference potential VSS, while the output of inverter Iv 1 is respectively connected with the data terminal of judging latch HR and one input of the NOT-OR circuit NR 2.

Next, operations of the non-contact/contact judging and switching unit 6 in this embodiment will be described with reference to the timing chart of FIG. 5.

In FIG. 5, timings of the signals are respectively illustrated, from the upper side to the lower side, in the sequence of a primary power source (node a of FIG. 4) outputted from the non-contact power supply circuit 14, a voltage for detection of judgment rectified with the diodes D1, D2 (node b of FIG. 4), a voltage for detection of drive inputted to the delay circuit DL1 (node c of FIG. 4), a reset signal outputted from the NOT-AND circuit ND (node d of FIG. 4), a latch pulse outputted from the NOT-OR circuit NR 1 (node e of FIG. 4), a judging signal outputted from the judging latch HR (node f of FIG. 4), an output signal outputted from the inverter Iv 1 (node g of FIG. 4) and a control signal for driving the transistors T1, T2 (node h of FIG. 4).

Moreover, in FIG. 5, the signal timing in the non-contact operation mode is indicated with a solid line, while the signal timing in the contact operation mode is indicated with a dotted line. Here, the non-contact operation mode of the IC card 1 will be described.

First, the coil 4 receives the radio wave of the card terminal, the primary power source is outputted from the non-contact power supply circuit 14 and the voltage for detection of judgment outputted from the diodes D1, D2 also rises to become high (Hi) level.

In this case, the reset signal (Hi level) is outputted from the NOT-AND circuit ND to reset the judging latch HR. The delay circuit DL1 outputs, when the voltage for detection of drive (node c) becomes Hi level at a certain time constant, such Hi level signal after a certain delay time. The NOT-AND circuit ND receives the Hi level signal outputted from the delay circuit DL 1 and outputs the low level (Lo) signal.

Moreover, since the voltage for detection of judgment is in the Hi level as described above, the signal (node g) outputted from the inverter Iv 1 becomes Lo level, while the control signal outputted from the inverter Iv 2 becomes Hi level.

The reset signal outputted from the NOT-AND circuit ND is delayed for a certain period with the delay circuit DL 2 and is then inputted to the other input of the NOT-OR circuit NR 1. The signal outputted from the delay circuit DL 2 is further delayed with the delay circuit DL 3 and is then inputted to one input of the NOT-OR circuit NR 1.

The NOT-OR circuit NR 1 outputs the latch pulse during the delay period of the delay circuit DL 2 and the delay circuit DL 3, and the judging latch HR latches the output signal (node g) of the inverter Iv 1 based on this latch pulse. Here, the non-contact/contact judging and switching unit 6 uses the DC voltage rectified with the diodes D1, D2 as the detection signal and thereby can reduce the detection period.

In this case, since the output of inverter Iv 1 is in the Lo level and the judging signal is also in the Lo level, the output (node h) of inverter Iv 2 provides an output of the signal of Hi level. Accordingly, the transistors T1, T2 turn OFF and the power supply voltage terminal VCC reaches the reference potential VSS.

Therefore, even when the power supply voltage terminal VCC is terminated with the ground terminal GND, a reverse current is prevented to flow.

Further, a chip layout of the semiconductor integrated circuit device 3 will be described with reference to FIG. 6.

In FIG. 6, at the upper part of the semiconductor chip CH, the non-contact RF unit is located, while at the upper part of this non-contact RF unit, the connection terminals LA, LB are respectively provided. In addition, at the lower part in the vicinity of the non-contact RF unit, a non-contact RAM and a non-contact ROM 10-1 as a part of the ROM 10 are also provided.

In the hatched region in FIG. 6, other part of the ROM 10, RAM 11, EEPROM 12, CPU, and the logic circuit including the clock generating circuit 5 and the non-contact/contact judging/switching unit 6 are formed to include these non-contact RAM 8 and the non-contact ROM 10.

In the peripheral area of the semiconductor chip CH, the clock terminal CLK, power source voltage terminal (contact power supply terminal) VCC, reset terminal RES, ground terminal (contact power supply terminal, reference potential terminal) GND and input/output terminals I/O1, I/O2 are also provided.

Moreover, in the peripheral area of power source voltage terminal VCC, the transistors T1, T2 are provided. Impedance can be lowered and thereby voltage-drop can also be controlled by providing the transistors T1, T2 in the vicinity of the power source voltage terminal VCC.

Here, the cross-sectional views of the transistors T1, T2 will be illustrated in FIG. 7.

In FIG. 7, an N-well Wn, for example, is formed on a semiconductor substrate HK consisting of a P-type silicon single-crystal substrate and the transistors T1, T2 are formed on this N-well Wn.

As illustrated in FIG. 8, parasitic diodes Dk1 to Dk4 formed on the semiconductor substrate HK are also formed to the transistors T1, T2 and the parasitic diodes Dk1, Dk2 of the transistor T1 are connected in the forward and backward directions by connecting in series these transistors T1, T2.

The parasitic diodes Dk3, Dk4 of the transistor T2 are also connected in the forward and backward directions. Thereby, it is possible to prevent that the voltage is generated at the power supply voltage terminal VCC via these parasitic diodes Dk1 to Dk4.

Moreover, FIG. 9 illustrates comparison of device size between the transistor T1 (T2) and ordinary P-channel MOS transistor Tp for logical operations.

As illustrated in the figure, the transistor T1 (T2) is, for example, about 700 times in the area ratio in comparison with that of the transistor Tp in view of lowering ON resistance. In this case, a transistor T1 (T2) is formed through parallel connection of n P-channel MOS transistors.

Therefore, according to this embodiment, when the IC card 1 is operated in the non-contact mode, only the transistors T1, T2 are turned OFF and the power supply voltage terminal VCC becomes equal to the reference potential VSS. Accordingly, if the power supply voltage terminal VCC is terminated to the ground terminal GND, erroneous operation of the IC card 1 can surely be prevented.

In addition, when the IC card 1 is operated in the non-contact mode, since the power supply voltage. terminal VCC becomes equal to the reference potential VSS, analysis of internal operation through monitoring of the power supply voltage terminal VCC can be prevented and thereby security of the IC card 1 can be remarkably improved.

The present invention has been described practically on the basis of the preferred embodiment thereof, but the present invention is not limited to such embodiment and naturally allows various changes and modifications within the scope not departing from the claims thereof.

For example, in this embodiment, the transistor for fixing the power supply voltage terminal to the reference potential VSS is formed of the P-channel MOS transistor, but this transistor may also be formed of an N-channel MOS transistor.

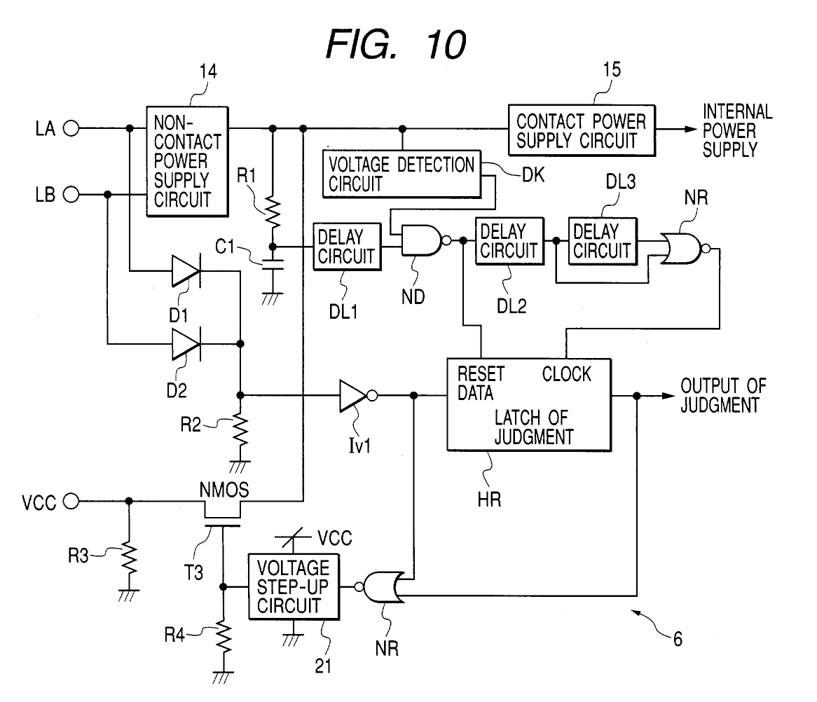

In this case, as illustrated in FIG. 10, the non-contact/contact judging and switching unit 6 is provided with the N-channel MOS transistor (isolation switch means) T3 in place of the transistors T1, T2 (illustrated) and a voltage step-up circuit 21 is newly provided to drive the transistor T3.

Influence of the parasitic diode can be eliminated by using the N-channel MOS transistor.

One connecting point of the transistor T3 is connected with the power supply voltage terminal VCC, while the other connecting point of the transistor T3 is connected with the output of the non-contact power supply circuit 14. The gate of transistor T3 is connected with the reference potential via the resistor R4.

Moreover, the gate of transistor T3 is connected to input a step-up voltage generated by the voltage step-up circuit 21. The control terminal of the voltage step-up circuit 21 is connected with the output of the NOT-OR circuit NR 2.

The voltage step-up circuit 21 starts the voltage step-up operation based on the signal outputted from the output of the NOT-OR circuit NR 2 and outputs the step-up voltage generated to the gate of transistor T3.

In addition, the structure and connection of the other non-contact/contact judging and switching unit 6 are same as those of FIG. 4 and therefore the description thereof is not duplicated here.

Accordingly, the ON resistance can be reduced in comparison with that of the transistors T1, T2 (illustrated in FIG. 4) by utilizing the transistor T3 of N-channel MOS.

The typical inventions of the present invention can provide the following effects.

(1) Since the isolation switch means is provided, erroneous operation of IC card can be prevented even if the contact power supply terminals are terminated during the non-contact operation mode.

(2) Security of the IC card during the non-contact operation can be improved remarkably by isolating the contact power supply terminal from the internal power supply during the non-contact operation mode.

(3) Moreover, reliability of the IC card can be very much improved through the items (1) and (2).

What is claimed is:

1. An IC card of dual-way type which is used in common as a contact type card and a non-contact type card, comprising:
an operation mode detecting unit for detecting non-contact operation to output a control signal; and
an isolation switch means for isolating a contact power supply terminal and an internal power supply from each other based on the control signal of said operation mode detecting unit.

2. An IC card according to claim 1, wherein said contact power supply terminal is at least any one of a power supply voltage terminal to which the power supply voltage is supplied and a reference potential terminal connected to a reference potential.

3. An IC card according to claim 2, wherein said isolation switch means is formed to two P-channel MOS transistors connected in series.

4. An IC card according to claim 3, wherein said isolation switch means is provided at an area near said contact power supply terminal.

5. An IC card according to claim 4, wherein a transistor size of said P-channel MOS transistor is larger than the MOS transistor for logical operation.

6. An IC card according to claim 5, wherein said operation mode detecting unit generates a DC voltage by rectifying a received radio wave and judges the non-contact operation by detecting said DC voltage.
